(19) United States
(12) Patent Application Publication
(10) Pub. No.: US 2011/0138440 A1
(43) Pub. Date: Jun. 9, 2011

(54) Downstream output level tilt compensation device between CATV distribution system and CATV user

(75) Inventors: Steven K. Shafer, Chittenango, NY (US); Erdogan Alkan, Fayetteville, NY (US)

(73) Assignee: John Mezzalingua Associates, Inc., Syracuse, NY (US)

(21) Appl. No.: 12/630,486

(22) Filed: Dec. 3, 2009

(51) Int. Cl. H04N 7/16

(52) U.S. Cl. 725/151

(57) ABSTRACT

A downstream bandwidth output level tilt compensation device that can be inserted into a signal transmission line of a CATV system on a premise of a user. The device includes first and second filters to output first and second band signals, respectively. Detectors output a measurement representative of a characteristic (e.g., RF power) in the first and second band signals, respectively. A comparator uses the measurements from the detectors to determine a correction signal. A variable slope adjusting circuit is provided to adjust the gain slope of the downstream bandwidth responsive to the correction signal. The device includes a third filter after the variable slope adjusting circuit to pass a third band signals corresponding to the first and second signals. A second comparator uses measurements from the third signal to adjust the connection signal.

### BACKGROUND OF THE INVENTION

The use of a cable television (“CATV”) system to provide Internet, Voice Over Internet Protocol (“VOIP”) telephone, television, and radio services is well known in the art. In providing these services, a downstream bandwidth (i.e., radio frequency (“RF”) signals, digital signals, optical signals, etc.) is passed from a supplier of the services to a user and an upstream bandwidth is passed from the user to the supplier. The downstream bandwidth is passed, for example, within relatively higher frequencies from within a total bandwidth of the CATV system while the upstream bandwidth is passed within relatively lower frequencies.

Traditionally, the size of the downstream bandwidth far exceeds the size of the upstream bandwidth because of the nature of the services provided. For example, while the downstream bandwidth must accommodate all of the television and radio programming along with Internet and VOIP downloading, the upstream bandwidth is only required to accommodate Internet, system control signals, and VOIP uploading. Problems are arising, however, due to an increase in upstream bandwidth usage caused by an increasing demand for higher speed Internet uploads and the increasing demand for the VOIP telephone services.

In an effort to increase the upstream flow of packets, several suppliers have a plan to increase the size of the upstream bandwidth from 5-42 MHz to 5-85 MHz to allow a greater flow of the upstream content. Along with such an increase, the downstream bandwidth must be correspondingly decreased in size because the total bandwidth is relatively fixed. Such a change is, however, very difficult to implement.

Even further, increasing the size of the upstream bandwidth forces suppliers to push their downstream content into increasingly higher frequency portions of the downstream bandwidth. Unfortunately, these higher frequencies are much more susceptible to parasitic losses in signal strength caused by the signal transmission lines, connectors on the user's premise, devices connected to the signal transmission lines on the user's premise, etc. In the past many users have added relatively low-tech drop amplifiers on their premise to account for such losses. Additionally, because of the increased demands placed on the downstream content (e.g., high definition television, increased compression, etc.) the signal strength (i.e., level) of the downstream bandwidth must be maintained to closer tolerances than can typically be provided by the typical low-tech drop amplifier. Accordingly, as a result of increasing the size of the upstream bandwidth, the quality of the content moved to the higher frequencies within the downstream bandwidth may be significantly lessened causing an increase in customer complaints and an increase in costly service calls.

### SUMMARY OF THE INVENTION

In accordance with one aspect of the present invention, the signal quality of the downstream bandwidth can be increased by reducing the effect of parasitic losses occurring within the CATV distribution system. The present invention is specifically adapted to be placed on a user's premise so that it can measure the downstream bandwidth and provide an appropriate amount of slope adjustment.

In accordance with one aspect of the present invention, a CATV system is provided for supplying CATV services from a supplier to a plurality of users or CATV subscriber(s). The system includes at least one discrete downstream bandwidth output level tilt compensation device that can be inserted into a signal transmission line of the CATV system at a premise of each user.

In accordance with one embodiment of the present invention, a downstream bandwidth output level tilt compensation device is provided that can be inserted into a signal transmission line of a CATV system on a premise of a user. The device can include a first low band filter to pass a first portion of a downstream signal, a second high band filter to pass a second portion of the downstream signal different from the first portion, a first signal power measurement device coupled to the first low band filter to output a first signal representative of a first power level of the first portion of the downstream signal, and a second signal power measurement device coupled to the second high band filter to output a second signal representative of a second power level of the second portion of the downstream signal. The device can include a comparator/differential amplifier to compare the first signal and the second signal to output a slope control value, and a slope adjustment circuit to adjust the downstream signal responsive to the slope control value received from the comparator. The downstream bandwidth output level tilt compensation device can include a third filter to pass a third portion of the downstream signal, where the third filter is downstream of the slope adjustment circuit, and where the third portion has a bandwidth corresponding to both of the first portion and the second portion, a third signal power measurement device configured to output a third signal representative of a power level of the third portion, a calibration device to modify a signal level of the third signal to output a correction value, and a second comparator/differential amplifier to compare the slope control value and the correction value from the calibration device to output a combined control value to the slope adjustment circuit.

In accordance with one embodiment of the present invention, a method for conditioning a downstream bandwidth on a premise of a user of CATV services can include receiving a supplier bandwidth from a CATV supplier, dividing an upstream bandwidth and a downstream bandwidth from the supplier bandwidth, passing the downstream bandwidth through first and second different passive filters to obtain low band and a high band, measuring a low band signal strength of the low band and a high band signal strength of the high band, comparing the low band signal strength to a first predetermined signal strength for a prescribed supplier bandwidth to output a first compensation amount, comparing the high band signal strength to a second predetermined signal strength for the prescribed supplier bandwidth to output a second compensation amount, comparing the first compensation amount and the second compensation amount to output a slope compensation value, and adjusting the downstream bandwidth by an amount of slope adjustment responsive to the slope compensation value and an adjustment value, and measuring a third portion of an adjusted downstream bandwidth to determine the adjustment value, where the third portion has a bandwidth corresponding to both of the low band and the high band.

### BRIEF DESCRIPTION OF THE DRAWINGS

For a further understanding of the nature and objects of the invention, references should be made to the following detailed description of a preferred mode of practicing the invention, read in connection with the accompanying drawings in which:

FIG. 1 is a graphical representation of a CATV system arranged in accordance with an embodiment of the present invention;

FIG. 2 is a graphical representation of a user's premise arranged in accordance with an embodiment of the present invention;

FIG. 3 is a circuit diagram representing a premise device including an automatic downstream bandwidth output level tilt compensation device made in accordance with an embodiment of the present invention;

FIG. 4 is a graphical representation of an exemplary gain curve and equalization determined in accordance with the device represented in FIG. 3.

FIG. 5 is a graphical representation of a gain curve determined in accordance with the device represented in FIG. 3;

FIGS. 6A-6C are diagrams that show an exemplary embodiment of a comparator for use with the device represented in FIG. 3; and

FIG. 7 is a circuit diagram representing a premise device including a downstream bandwidth output level tilt compensation device made in accordance with another embodiment of the present invention.

### DETAILED DESCRIPTION OF THE INVENTION

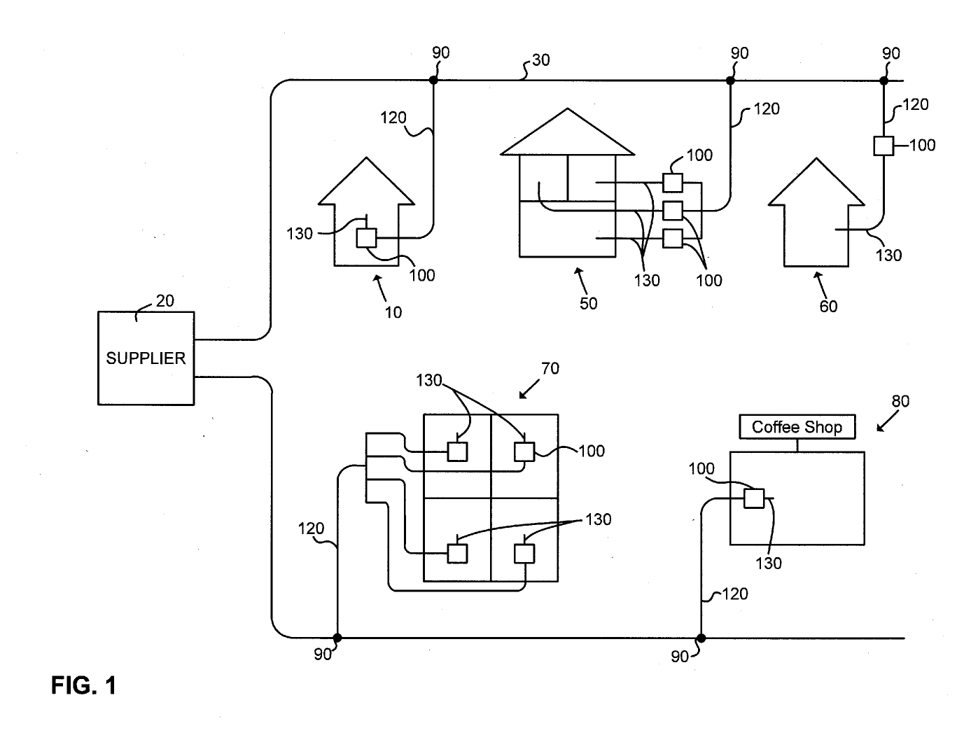

As shown in FIG. 1, a CATV system typically includes a supplier 20 that transmits a downstream bandwidth, such as RF signals, digital signals, and/or optical signals, to a user through a main distribution system 30 and receives an upstream bandwidth, such as RF signals, digital signals, and/or optical signals, from a user through the same main signal distribution system 30. A tap 90 is located at the main signal distribution system 30 to allow for the passage of the downstream/upstream bandwidth from/to the main signal distribution system 30. A drop transmission line 120 is then used to connect the tap 90 to a house 10, 60, an apartment building 50, 70, a coffee shop 80, and so on. As shown in FIG. 1, a premise device 100 according to embodiments of the present invention may be connected in series or in parallel between the drop transmission line 120 and a user's premise distribution system 130.

Referring still to FIG. 1, it should be understood that the premise device 100 can be placed at any location between the tap 90 and the user's premise distribution system 130. This location can be conveniently located within a premise (e.g., the house 10, the apartment building 50, exterior, etc.), or proximate to the premise (e.g., the house 60, the apartment building 70, etc.). It should be understood that the premise device 100 can be placed at any location, such as the coffee shop 80 or other business, where CATV services, including Internet services, VOIP services, or other unidirectional/bidirectional services are being used.

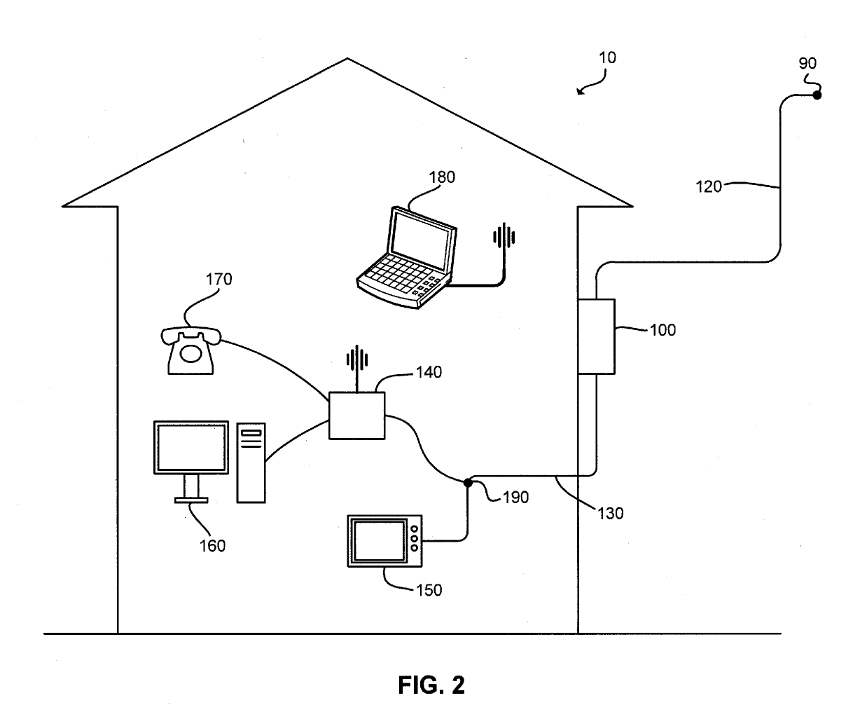

As shown in FIG. 2, the user's premise distribution system 130 may be split using a splitter 190 so that downstream/upstream bandwidth can pass to/from a television 150 and a modem 140 in accordance with practices well known in the art. The modem 140 may include VOIP capabilities affording telephone 170 services and may include a router affording Internet services to a desktop computer 160 and a laptop computer 180, for example.

Additionally, it is common practice to provide a set-top box (“STB”) or a set-top unit (“STU”) for use directly with the television 150. For the sake of clarity, however, there is no representation of a STB or a STU included in FIG. 2. The STB and STU are mentioned here in light of the fact that many models utilize the upstream bandwidth to transmit information relating to “pay-per-view” purchases, billing, utilization, and other user interactions, all of which may require information to be sent from the STB or STU to the supplier 20. Accordingly, it should be understood that even though FIG. 2 explicitly shows that there is only one premise device 100 used for one device (i.e., the modem 140), each premise device 100 may be used with more than one device (e.g., a modem, a STB, a STU, and/or a dedicated VOIP server) that transmit desirable upstream information signals via the upstream bandwidth.

Further, while not shown explicitly in FIG. 2, there may be one or more premise devices 100 located within or proximate to a single premise. For example, there may be a premise device 100 located between the modem 140 and the splitter 190 and another premise device 100 located between an STB or STU on the television 150 and the splitter 190. Similarly, there may be a premise device 100 located at any point in the premise distribution system 130 where an upstream bandwidth is being passed (e.g., from a modem, a STB, a STU, a VOIP server, etc.).

Further, while not shown explicitly in FIG. 2, there may be one premise device 100 located proximate to two user premises when there is one drop transmission line 120 used to connect the tap 90 to both of the two user premises. Even though such an arrangement is not considered ideal, because the upstream bandwidth from two users may be merged, such an arrangement may be necessary when the two premises are located too closely to one another for the physical placement of separate premise devices 100. In one embodiment, there may be one premise device 100 for more than two user premises.

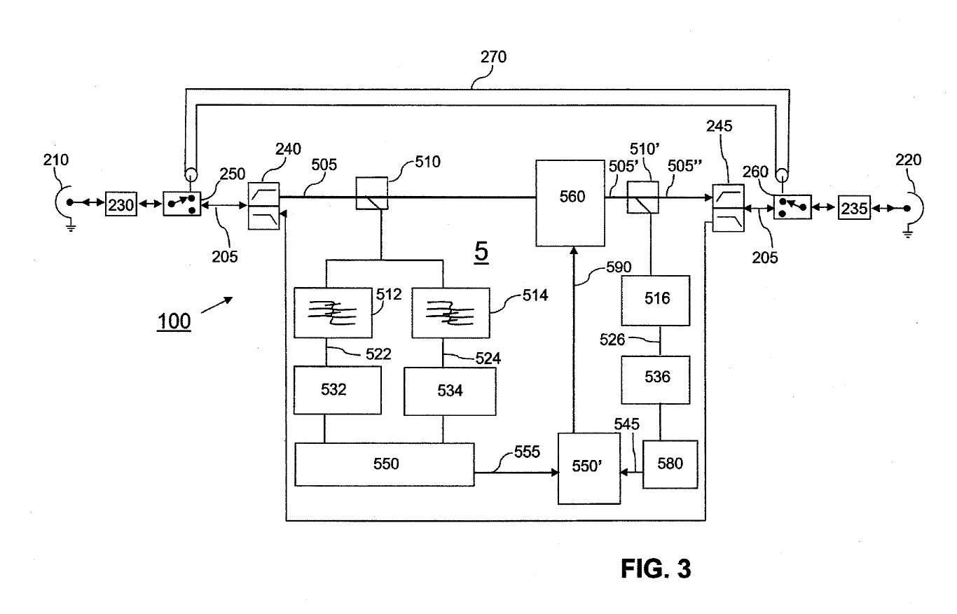

FIG. 3 is a diagram that shows an embodiment of a premise device 100 according to the present invention.

As shown in FIG. 3, a premise device 100 includes a supplier side 210 and a premise side 220. The supplier side 210 is positioned to receive the downstream bandwidth from the supplier 20 (FIG. 1) and to send the upstream bandwidth to the supplier 20. The premise side 220 is positioned to send the downstream bandwidth to the user and to receive the upstream bandwidth from the user. Each of the supplier side 210 and the premise side 220 can include a threaded 75 ohm connector so that the premise device 100 can be easily placed in series with the drop transmission line 120 and the premise distribution system 130. Alternatively, each of the supplier side 210 and the premise side 220 may include a proprietary connector (e.g., to hinder attempts at tampering with or theft of the premise device 100). Other connectors may also be used depending on the type and/or size of the drop transmission line 120, the premise distribution system 130, or a system impedance other than 75 ohms.

The premise device 100 preferably includes a surge or lightning protection device 230 positioned near the supplier side 210 and a surge or lightning protection device 235 positioned near the premise side 220. Having two surge protection devices 230, 235 attempts to protect the premise device 100 from energy passing from the drop transmission line 120 from a lighting strike and from energy passing from the premise distribution system 130 from a lighting strike. It should be understood that the lightning protection devices may not be necessary if/when the premise device 100 is configured to be placed in a CATV system that utilizes non-conductive signal transmission lines. Any of the high quality, commercially available surge protection devices will function well within the specified locations within the premise device 100.

The premise device 100 preferably includes two power bypass failure switches 250, 260 that route all of the upstream\downstream signals through a bypass signal path 270 (e.g., a coaxial cable, an optical cable, a microstrip, a stripline, etc.) in the event of a power outage. The bypass failure switches 250, 260 are preferably located near the supplier side 210 and premise side 220, respectively. In an effort to protect the bypass failure switches 250, 260 from damage due to lightning energy, the bypass failure switches 250, 260 are preferably placed between the surge protection devices 230, 235.

Each of the bypass failure switches 250, 260 includes a default position bypassing the upstream/downstream signals through the bypass signal path 270 at any time power is removed from the premise device 100. When power is applied, each of the bypass failure switches 250, 260 actuate to a second position that disconnects the bypass signal path 270 and passes all of the upstream\downstream signal transmissions along another path 205. The switches may also be controlled such that when there is a fault detected in the premise device 100 that could abnormally hinder the flow of the upstream\downstream bandwidths through the signal path 205, the switches 250, 260 are moved to their default position sending the upstream/downstream signal transmissions through the bypass signal path 270. Any of the high quality, commercially available signal transmission switches will function well within the specified locations within the premise device 100. The bypass signal path 270 can be any suitable coaxial cable or optical cable depending on the CATV system configuration.

Referring to FIG. 3, a signal path 205 from the supplier side 210 to the premise side 220 can include two discrete signal paths, a high frequency signal path 505, and a low frequency signal path 570. The split signal path is formed using a pair of first frequency band splitting devices 240, 245 that can provide the bandwidth frequency ranges for a signal bandwidth respectively transmitted on communication paths 505, 570. A cutoff frequency set by a pair of frequency band splitting devices 240, 245 can correspond to various DOCSIS specifications. Any of the high quality, commercially available frequency band splitting devices will function well within the specified locations within the premise device 100.

The premise device 100 preferably includes circuit components comprising an embodiment of a downstream bandwidth output level tilt compensation device. As shown in FIG. 3, the premise device 100 can include a downstream bandwidth output level tilt compensation device 5 that helps to maintain a desired signal quality in transmitted signals using relatively high frequencies within the downstream bandwidth. The downstream bandwidth output level tilt compensation device 5 can include a coupler 510, at least two filters 512, 514 (e.g., passive, fixed) passing different downstream bands of the downstream bandwidth, power detectors 532, 534, comparator circuit 550 and a slope adjustment circuit 560. The downstream bandwidth output level tilt compensation device 5 can further include a coupler 510′, filter 516 (e.g., passive, fixed), power detector 536, calibration device 580 and a second comparator 550′.

At a simplistic level, the downstream bandwidth output level tilt compensation device 5 can detect a selected signal of the downstream bandwidth in at least two portions before a slope adjustment circuit 560 and in a third portion after a slope adjustment circuit 560. The at least two portions before the slope adjustment circuit 560 can be different sized bandwidths or overlapping bandwidths. The downstream bandwidth output level tilt compensation device 5 can detect the selected signal of the downstream bandwidth before a slope adjustment circuit 560 to set a first compensation signal (e.g., compensation signal 555) for the slope adjustment circuit 560. In one embodiment, the downstream bandwidth output level tilt compensation device 5 can use the selected signal of the downstream bandwidth in the third portion for comparison (e.g., to modify or fine tune) to the compensation signal 555. The downstream bandwidth output level tilt compensation device 5 can compare the third portion (e.g., a single bandwidth) downstream of the slope adjustment circuit 560 to the selected signal detected upstream of the slope adjustment circuit 560 to improve or provide the desired signal quality in transmitted signals in the downstream bandwidth (e.g., further adjust or validate a compensation signal (e.g., the compensation signal 555)).

The downstream bandwidth output level tilt compensation device 5 separates at least two different portions of the downstream bandwidth before the slope adjustment circuit 560, compares observed power levels detected in the two different portions to respective corresponding reference levels for the known supplier configuration (e.g., of the downstream bandwidth), determines a compensating slope for use by a slope adjusting circuit (e.g., variable) to create a premise downstream bandwidth 505′ output having a desired gain curve (e.g., flat from 54 MHz to 1 GHz) across all or part the downstream bandwidth. The gain curve is a curve representative of transmitted signal strengths across the downstream bandwidth.

In one embodiment, a low band portion and a high band portion respectively passed by filters 512, 514 can be two or more channels (e.g., each channel including a plurality of carriers in a bandwidth of 6 MHz), 10 or more channels, at least 20% of the downstream bandwidth, at least 40% of the downstream bandwidth, or up to 50% of the downstream bandwidth. In one embodiment, each channel is a TV channel. In one embodiment, the low band portion and the high band portion are from the lower frequency half and the upper frequency half of the downstream bandwidth, respectively.

The downstream bandwidth output level tilt compensation device 5 obtains the downstream bandwidth from a directional coupler 510 drawing the downstream bandwidth off of the high frequency signal path 505 upstream of the slope adjustment circuit 560 and from a directional coupler 510′ downstream of the slope adjustment circuit 560. Please note that these signals will be referred to herein as the coupled downstream bandwidth. The coupled downstream bandwidth is provided to a low bandpass filter 512 and a high bandpass filter 514. In one embodiment, the filter 512 can pass a first frequency band up to a lower frequency half of the coupled downstream bandwidth. Alternatively, the filter 512 can pass a frequency band such as 54-270 MHz, 54-550 MHz, 100-200 MHz, or 100-350 MHz. In one embodiment, the filter 514 can pass a second frequency band up to a higher frequency half of the coupled downstream bandwidth. Alternatively, the filter 514 can pass a frequency band such as 270-550 MHz, 300-550 MHz, 450-860 MHz, 100-200 MHz, or 550 MHz-1 GHz. Further, the first and second frequency band can be different frequency bands in one half of the coupled downstream band. In one embodiment, the coupled downstream bandwidth is provided to a signal measurement circuit. In one embodiment the filter 512 can have a different bandwidth (e.g., different, smaller, larger) than the filter 514. Different size bandwidths can depend on filter crossover or bandgap configurations. The comparator 550 can adjust for such different bandwidth sizes (e.g., by controlling a reference voltage for at least one of the low band signal 522 or the high band signal 524).

In one embodiment, the low band signal 522 and the high band signal 524 can overlap in frequency (e.g., 54-300 MHz, 300-550 MHz). Such an overlap can increase a power level detected by detectors 532 and/or 534, respectively.

The coupled downstream bandwidth from the coupler 510′ is provided to a filter 516 that can pass at one time a third frequency band corresponding to a portion of the coupled downstream bandwidth transmitted by the filter 512 and the filter 514. In one embodiment, the downstream bandwidth output level tilt compensation device 5 can analyze 100% of the coupled downstream bandwidth.

The filter 512 passes a low band signal 522 that can include channels located near the lowest frequency within the coupled downstream bandwidth while the filter 514 passes a high band signal 524 that can include channels located near the highest frequency within the coupled downstream bandwidth. Even though the low band signal 522 and the high band signal 524 are depicted in FIG. 3 as a range of frequencies, for clarity, it should be understood that each could include a few as two channels or up to half of the coupled downstream bandwidth. It should also be understood that the low band signal 522 and the high band signal 524 do not need to include the lowest or highest frequency channels, respectively. It is beneficial, however that the two bands be spaced apart from one another as practical to better estimate the amount of parasitic loss experiences across the entire downstream bandwidth.

Power detector 532 and power detector 534 respectively receive the low band signal 522 and the high band signal 524. The power detectors 524, 534 can convert received energy to a DC voltage. In one embodiment, power detectors 524, 534 can convert the RF energy in low and high band RF signals from the filters 512, 514 to a DC voltage. Power detector 536 receives the passed signal or the combined band signal 526 and converts the received energy therein to a DC voltage. In one embodiment, the signals 522, 524, 526 can be RF signals. Any of the high quality, commercially available power detector devices will function well within the specified locations within the downstream bandwidth output level tilt compensation device 5.

A comparator 550 can receive the voltages from the power detector 532 and the power detector 534. The comparator 550 can be used to compare the difference between the two voltages to determine a compensation signal 555 (e.g., that could be used to set and/or adjust the slope adjustment circuit 560).

In one embodiment, the low band signal 522 and the high band signal 524 pass portions or a subset of a known coupled downstream bandwidth that varies in a prescribed configuration based on at least service location, service provider, and user profile (e.g., basic cable service, tier 1 cable service, tier 2 cable service, etc.), which can individually or in combination change channel transmission status or characteristics (e.g., power level) in the band signals 522, 524.

In one embodiment, the comparator 550 can independently set a reference level for incoming low band signal 522 and/or the high band signal 524. Such a reference level can be used to compensate power fluctuations that can occur in the low band signal 522 or the high band signal 524 because of filter characteristics or a prescribed channel configuration of the signals 522, 524 or carriers transmitted therein (or modifications thereto) for the downstream bandwidth from the supplier.

A comparator 550′ can receive the compensation signal 555 from the comparator 550 and a calculated value (e.g., a voltage) that is a signal representative of the RF power in the combined signal 526 to output a final compensation value 590 to the slope adjustment circuit 560. In one embodiment, the calibration device 580 can receive the representative power level (e.g., DC voltage) from the power detector 536 to output a corresponding adjusted signal 545 to the comparator 550′. In one embodiment, the final compensation value 590 can be a corrected and/or verified compensation signal 555. In one embodiment, the final compensation value 590 is the compensation signal 555 modified (e.g., responsive to the adjusted signal 545) to address unequal carrier loading in the low band signal 522 and the high band signal 524.

It should be understood that parasitic losses affect higher frequencies more than lower frequencies. Accordingly, if a known signal having a −10 dB signal strength, for example, is transmitted at various frequencies across the entire downstream bandwidth and across a length of coaxial/optical cable, a plot of the resulting gain would result in a curve, which is known. Since the end goal is to have a gain curve that is a straight line or to have a gain curve that has an increasing slope (e.g., slightly) versus frequency, the slope adjustment circuit 560 can operate to adjust the downstream signal transmission characteristic (e.g., gain curve) such that the lower frequencies are lower in amplitude than the higher frequencies.

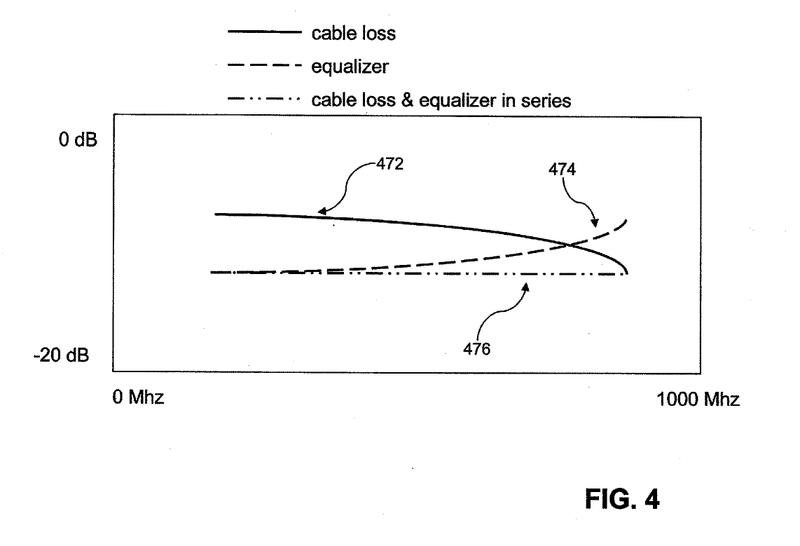

In one embodiment, the slope adjustment circuit 560 can apply a linear signal adjustment (e.g., attenuation) to the downstream bandwidth 505. Alternatively, the slope adjustment circuit 560 can apply a non-linear signal adjustment to the downstream bandwidth 505. In one embodiment, the slope adjustment circuit 560 can include a variable slope adjusting circuit for varying the adjustment (e.g., rate of slope adjustment). For example, as shown in FIG. 4, an exemplary gain curve 472 can be plotted across the entire downstream bandwidth 505, which is shown, for example, as being from 100 MHz to 880 MHz. A signal adjustment (e.g., equalizer 474) provided by the slope adjustment circuit 560 should result in substantially flat gain curve for the adjusted downstream bandwidth 505′ (e.g., gain characteristic 476) when the downstream bandwidth output level tilt compensation device 5 processes (e.g., continuously) the coupled downstream bandwidth (e.g., signal gain characteristic 472).

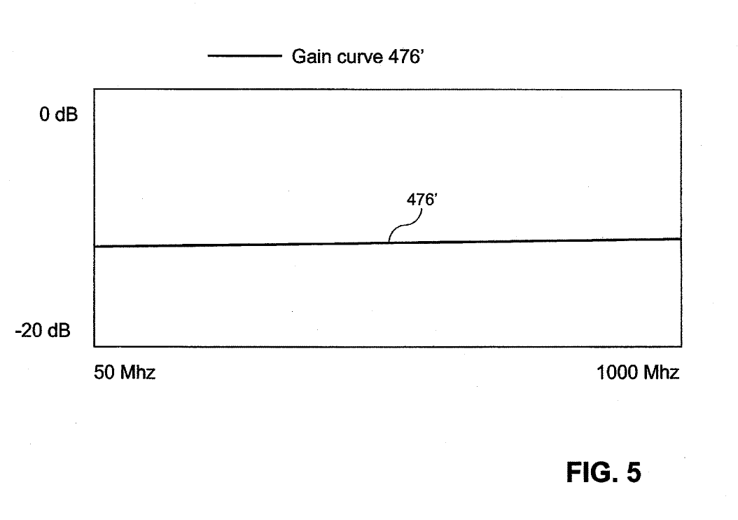

As described herein, it may be desirable for the downstream bandwidth output level tilt compensation device 5 to increase the amount of level adjustment applied and increase the curvature of the slope adjustment to result in a gain characteristic 476′, which has an increasing slope toward the higher frequencies. The exemplary increasing slope gain characteristic 476′ for the downstream bandwidth 505′ is shown, for example, as being from 50 MHz to 1000 MHz in FIG. 5.

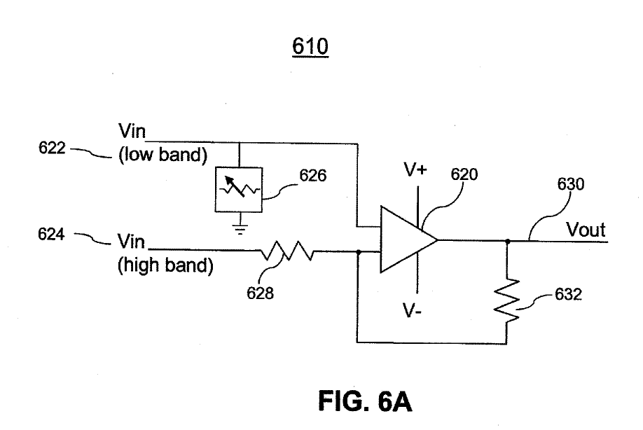

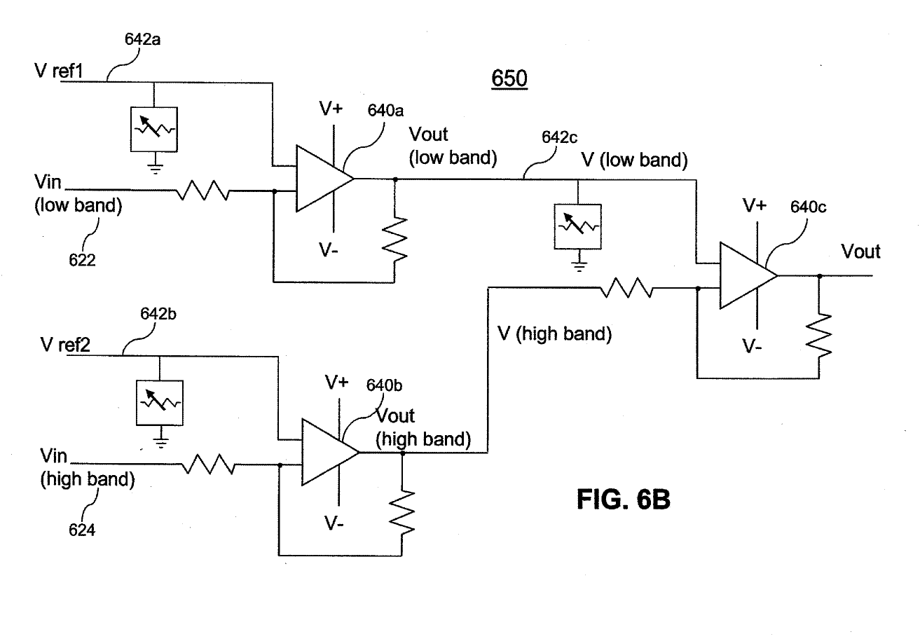

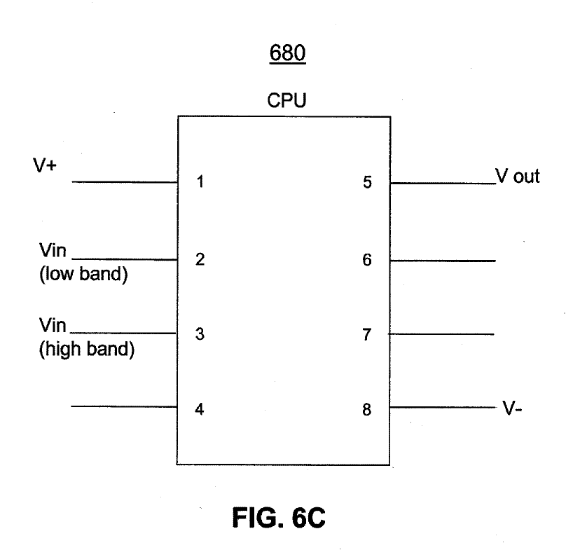

FIG. 6A is a diagram that shows an exemplary embodiment of a comparator. As shown in FIG. 6A, a comparator 610 can be used for the comparator 550, 550′; however, embodiments of the application are not intended to be limited thereby.

As shown in FIG. 6A, the comparator circuit 610 includes an operational amplifier 620 that receives a first signal 622 (e.g., a DC voltage representative of RF power in the low band signal 522) at an inverting input terminal. The first signal 622 is modified by a variable resistor 626 before being input to the operational amplifier 620. In one embodiment, the variable resistor 626 can be a potentiometer. The variable resistor 626 can operate as an offset value (e.g., as a variable voltage divider) to determine when and/or by how much the first signal 622 varies from a desired level.

As shown in FIG. 6A, reference voltages V+, V− can be used to set an input threshold voltage level for the operational amplifier 620, and resistors 632 and 628 are provided to increase stability or reduce noise effect by generating a controllable hysteresis effect for the comparator circuit 610.

At a simplistic level, the comparator circuit 610 is used to compare physical measurements in the case that those physical variables can be translated into voltage signals. For instance, a power detector 534 can be coupled to a high band portion of the downstream signal to produce a voltage proportional to the RF power contained in that high band portion of the downstream signal. The produced voltage (high band) can be compared to a “set-point”or prescribed voltage representative of a known gain characteristic curve for that portion (high band) or another portion of the downstream signal. As shown in FIG. 6A, the reference level for the operational amplifier in the comparator circuit 610 is provided by the RF power in the low band portion of the downstream signal. Further, the variable resistor 626 can set the value of the first signal 622 to a reference level depending on the expected power in the low band portion, which can vary among suppliers 20 or vary even within configurations used by a single supplier 20 among different locations.

FIG. 6B is a diagram that shows an exemplary embodiment of a comparator. As shown in FIG. 6B, a comparator circuit 650 can be used for the comparator 550, 550′; however, embodiments of the application are not intended to be limited thereby.

As shown in FIG. 6B, the comparator circuit 650 includes operational amplifiers 640a, 640b, and 640c. The operational amplifiers 640a and 640b each having respective reference voltages 642a, 642b input to inverting input terminals thereof and input signals representative of a low band signal characteristic (e.g., RF power) 622 and of a high band signal characteristic (e.g., RF power) 624, respectively. The reference voltages 642a and 642b can be independently controlled to offset the input signals to a known value or condition, which can represent a corresponding prescribed portion of the downstream signal. The operational amplifier 640c can operate similar to the comparator circuit in FIG. 6A.

As shown in FIG. 6C, a comparator circuit 680 can be implemented as an integrated circuit in this example as part of an 8 pin CPU. As shown in FIG. 6C, a comparator circuit 680 can be used for the comparator 550, 550′; however, embodiments of the application are not intended to be limited thereby.

The downstream bandwidth output level tilt compensation device 5 can perform error detection or correction by comparing characteristics (e.g., RF energy or power level) of the combined signal 526 to characteristics of the corresponding signal detected in at least two portions represented by the low band signal 522 and the high band signal 524. Preferably, the combined signal 526 is obtained downstream of the slope adjustment circuit 560 and the signals 522, 524 (e.g., divided signals) are obtained upstream of the slope adjustment device, however, embodiments of the application are not intended to be so limited.

As described herein, the downstream bandwidth output level tilt compensation device 5 can compare a signal characteristic before a signal correction device (e.g., a slope adjusting circuit) located in the downstream bandwidth 505 to a signal characteristic (e.g., power level) of the downstream bandwidth (e.g., corrected signal) 505′ to create a premise downstream bandwidth 505″ output having a desired gain curve (e.g., flat from 54 MHz to 1 GHz) across all or part the downstream bandwidth.

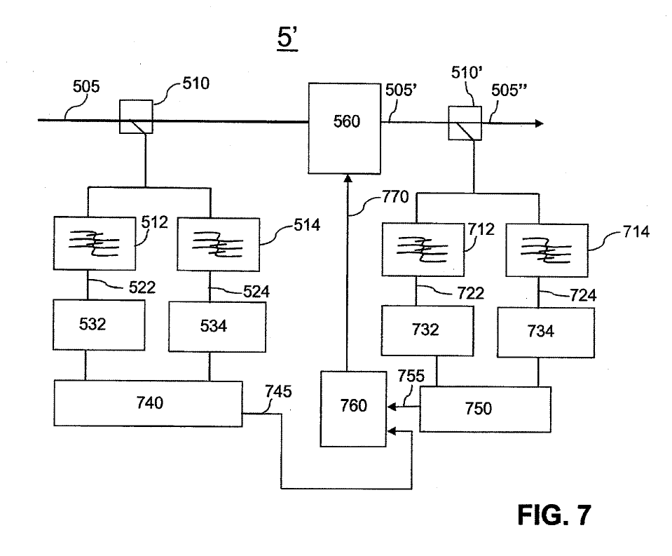

FIG. 7 shows another embodiment of a downstream bandwidth output level tilt compensation device 5′, which can be use with a premise device 100 to help to maintain a desired signal quality in transmitted signals in the downstream bandwidth. The downstream bandwidth output level tilt compensation device 5′ can include a coupler 510, at least two filters 512, 514 (e.g., passive) passing different downstream bands of the downstream bandwidth, power detectors 532, 534, differential amplifier 740 and a slope adjustment circuit 560. The downstream bandwidth output level tilt compensation device 5′ can further include a coupler 510′, at least two filters 712, 714 (e.g., passive) passing different downstream bands of the downstream bandwidth, power detectors 732, 734, differential amplifier 750 and a third differential amplifier 760.

At a simplistic level, the downstream bandwidth output level tilt compensation device 5′ can detect a selected signal of the downstream bandwidth in at least two portions before a slope adjustment circuit 560 and in at least two portions after the slope adjustment circuit 560. The downstream bandwidth output level tilt compensation device 5′ can detect the selected signal of the downstream bandwidth before a slope adjustment circuit 560 to set a compensation signal for the slope adjustment circuit 560 and can compare the selected signal of the downstream bandwidth detected in at least two portions downstream of the slope adjustment circuit 560 to further adjust or validate the compensation signal and provide the desired signal quality in transmitted signals in the downstream bandwidth 505″.

The differential amplifier 740 can receive representative signals or the voltages from the power detector 532 and the power detector 534. The differential amplifier 740 can be used to output (e.g., compare) the difference between the two input voltages to output a compensation signal 745 that can be used to set and/or adjust the slope adjustment circuit 560. In one embodiment, the compensation signal 745 can be a positive or negative voltage directly transmitted to the slope adjustment circuit 560.

The downstream bandwidth output level tilt compensation device 5′ can perform error detection or correction by comparing characteristics (e.g., RF energy or power level) of the downstream signal 505′ detected in at least two portions represented by a first band signal 722 and a second band signal 724. The differential amplifier 750 can receive representative signals or the voltages from the power detector 732 and the power detector 734. The differential amplifier 750 can be used to output the difference between the two input voltages from detectors 732, 734 to output an adjusting compensation signal 755 that can be used to adjust the slope adjustment circuit 560. Preferably, the differential amplifier 760 can receive representative signals or the voltages 745, 755 from the differential amplifiers 740, 750 and output the difference therebetween as final compensation value 770.

As described herein, the downstream bandwidth output level tilt compensation device 5′ can compare an upstream signal characteristic for a signal correction device (e.g., a slope adjusting circuit) located in the downstream bandwidth 505 to a signal characteristic (e.g., power level) of the downstream bandwidth (e.g., corrected signal) 505′ to create a premise downstream bandwidth 505″ output having a desired gain curve (e.g., 476′) across all or part the downstream bandwidth.

In one embodiment, the at least two filters 712, 714 can be the same, similar or different from the at least two filters 512, 514. In one embodiment, only the components downstream of the slope adjustment circuit 560 in device 5′ can be used where the third differential amplifier 760 can compare adjusting compensation signal 755 to a prescribed reference voltage. In some exemplary embodiments, the detection components downstream of the slope adjustment circuit 560 (e.g., detectors 732, 734 and differential amplifier 750) can be adjusted to output the downstream signals 505″ as gain curve 476 or 476′.

Embodiments of downstream bandwidth output level tilt compensation devices and/or methods of using the same were described using two portions (e.g., a first or low band and a second or high band) of the coupled bandwidth. However, embodiments are not intended to be so limited. For example, three portions (e.g., a third or middle band) of the coupled bandwidth or four portions of the coupled bandwidth can be used according to embodiments of the application.

The premise device 100 may also include a capability for the transfer of information transmission signals to and from the premise device 100 using known methods.

In one embodiment, the downstream bandwidth output level tilt compensation device 5 can provide to the supplier (e.g., via a modem) a serial code/number; date/time code stamp; slope voltage (e.g., compensation signal 590 (or 555)); voltage (low); voltage (high); an error code such as when the low band signal 522 drops below a threshold). Also, the downstream bandwidth output level tilt compensation device 5 could receive from the supplier (e.g., via a modem), reference voltages for the comparator to connect for power characteristics in the downstream bandwidth. For example, the downstream bandwidth output level tilt compensation device 5 could be installed operative with a downstream bandwidth up to 550 MHz, which is later modified to 860 MHz. In one embodiment, a microprocessor can control the downstream bandwidth output level tilt compensation device 5. For example, a microprocessor can be coupled to the downstream bandwidth output level tilt compensation device 5 and the modem to control settings (e.g., timing, reference values such as voltages, slope adjustment measurements, etc.) used to operate the downstream bandwidth output level tilt compensation device 5.

In one embodiment, the premise device 100 may be used to (1) automatically transfer the operational information to a remote site or a technician via the Internet, (2) transfer the operational information to the remote site or the technician only when requested to so, and/or (3) transfer information to the remote site or the technician when a problem or other error is detected. To accomplish these tasks, the premise device 100 may also be provided with a capability (e.g., modem, switch/splitter/router) that may allow connections to be made by other devices, such as a computer, to the modem for the purpose of communicating to the premise device and for the purpose of communicating via the Internet. The premise device 100 can collect and report out operational data relevant to the corresponding premise. Such a capability may include one or more antennas, one or more wired connections, such as RJ45, USB, Firewire, RS232, parallel, etc, and/or a VOIP server and may be used to wirelessly connect the computer 160, the telephone 170, and/or the television 150.

Further, the downstream bandwidth output level tilt compensation device 5 may allow control from outside to operate in a particular manner. Such control could be accomplished via the Internet over the CATV system, via a wireless communication protocol, and/or via a hardwired connection.

In one embodiment, a compensation signal can be a positive or negative voltage transmitted to the slope adjustment circuit 560. In one embodiment, a compensation signal can be a plurality of slope control adjustment values. An exemplary slope adjustment circuit can inversely adjust the slope across the downstream bandwidth responsive to the compensation signal.

In one embodiment, a compensation signal beneficially allows the detected information (e.g., detected power in the low band signal and the high band signal) to be interpolated across the entire downstream bandwidth. Using the compensation signal, the slope adjustment circuit determines how much signal level adjustment to apply and in what manner to apply the level adjustment across the entire downstream bandwidth such that the a resulting gain curve across the entire downstream bandwidth (e.g., 505′) is nearly linear and preferably with a slight increase in gain toward the higher frequencies in anticipation of parasitic losses that can occur downstream from the premise device 100. For example, the slope adjustment circuit 560 can use a 10 dB gain curve across the entire downstream bandwidth. For example, the amount of slope compensation can be determined by the high band signal strength including any interpolation to the highest frequency of the downstream bandwidth in combination with the low band signal strength including any interpolation to the lowest frequency of the downstream bandwidth.

Embodiments of downstream bandwidth output level tilt compensation devices and/or methods of using the same were described using comparators. However, embodiments according to the application are not intended to be so limited, for example, differential amplifiers can be used to take two inputs (e.g., variable inputs) and output the difference (e.g., variable difference) between the two inputs or a representative variation thereof.

While not shown, a variable output level compensation devices such as an amplifier can be added to adjust the downstream bandwidth between the supplier side 210 and premise side 220 (e.g., in the premise device 100). It should be understood that the term “variable output level compensation device” used herein should be understood to include not only a variable attenuation device, but also circuits containing a variable amplifier, AGC circuits, other variable amplifier/attenuation circuits, and related optical circuits that can be used to alter the signal strength of signals in the downstream bandwidth.

Embodiments of the downstream bandwidth output level tilt compensation device and methods for same can be activated automatically upon initialization of the premise device 100, and operate continuously to compensate the downstream bandwidth. Alternatively, adjustment by the downstream bandwidth output level tilt compensation device can be performed periodically, repeatedly, intermittently, responsive to a condition, or responsive to an inquiry or operator action.

While the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements. Also, while a number of particular embodiments have been set forth, it will be understood that features and aspects that have been described with reference to each particular embodiment can be used with each remaining particularly set forth embodiment. For example, aspects or features described with respect to embodiments directed to FIG. 3 can be used with embodiments directed to FIG. 7.

We claim:

1. A downstream bandwidth output level tilt compensation device that can be inserted into a signal transmission line of a CATV system on a premise of a user, the device comprising:
a first low band filter to pass a first portion of a downstream signal;
a second high band filter to pass a second portion of the downstream signal different from the first portion;
a first signal power measurement device coupled to the first low band filter to output a first signal representative of a first power level of the first portion of the downstream signal;
a second signal power measurement device coupled to the second high band filter to output a second signal representative of a second power level of the second portion of the downstream signal;
a comparator to compare the first signal and the second signal to output a slope control value;
a slope adjustment circuit to adjust the downstream signal responsive to the slope control value received from the comparator; and
a third filter to pass a third portion of an adjusted downstream signal, where the third filter is downstream of the slope adjustment circuit, and where the third portion has a bandwidth corresponding to both of the first portion and the second portion;
a third signal power measurement device configured to output a third signal representative of a power level of the third portion;
a calibration device to modify a signal level of the third signal to output a correction value; and
a second comparator to compare the slope control value and the correction value from the calibration device to output a combined control value to the slope adjustment circuit.

2. The device of claim 1, wherein the slope adjustment circuit comprises:
a variable slope adjusting circuit,
wherein the comparator comprises a microprocessor.

3. The device of claim 1, wherein the first portion of the downstream signal is from a lower frequency half of the downstream signal, and the second portion of the downstream signal is from an upper frequency half of the downstream signal, the slope adjustment circuit is configured such that a signal level corresponding to the second portion is greater than a signal level corresponding to the first portion.

4. The device of claim 1, wherein the slope control value comprises a plurality of slope control adjustment values providing signal level adjustment for the downstream signal representative of the signal transmission line used on or near the premise of a CATV subscriber.

5. The device of claim 4, wherein the plurality of slope control adjustment values are inversely representative of the signal transmission line used on or near the premise of the CATV subscriber.

6. The device of claim 1, wherein an amount of slope adjustment provided by a variable slope adjusting circuit is determined based on the first signal and the second signal and a rate of slope adjustment is based on a difference.

7. The device of claim 1, wherein a signal measurement circuit is arranged to measure the first portion and the second portion in a signal path for downstream signals only.

8. The device of claim 1, wherein the first portion of the downstream signal and the second portion of the downstream signal are different sizes or the first portion of the downstream signal and the second portion of the downstream signal overlap in frequency.

9. A method for conditioning a downstream bandwidth on a premise of a user of CATV services, the method comprising:
receiving a supplier bandwidth from a CATV supplier;
dividing an upstream bandwidth and the downstream bandwidth from the supplier bandwidth;
passing the downstream bandwidth through first and second different passive filters to obtain a low band and a high band;
measuring a low band signal strength of the low band and a high band signal strength of the high band;
comparing the low band signal strength to a first predetermined signal strength for a prescribed supplier bandwidth to output a first compensation amount;
comparing the high band signal strength to a second predetermined signal strength for the prescribed supplier bandwidth to output a second compensation amount;
comparing the first compensation amount and the second compensation amount to output a slope compensation value;
adjusting the downstream bandwidth by an amount of slope adjustment responsive to the slope compensation value; and
measuring a third portion of an adjusted downstream bandwidth, where the third portion has a bandwidth corresponding to both of the low band and the high band.

10. The method of claim 9, where the low band and the high band are different sizes, or where the low band and the high band overlap in frequency.

11. The method of claim 9, where the low band and the high band comprise the downstream bandwidth.

12. The method claim 9, wherein the amount of slope adjustment is representative of a signal transmission line used on or near a premises of a subscriber.

13. The method of claim 9, wherein the adjusting the downstream bandwidth is repeatedly performed or continuously performed.

14. The method of claim 9, wherein the low band comprises signals between 54-150 MHz, 54-270 MHz, 54-550 MHz, 100-172 MHz, 100-270 MHz, or 100-550 MHz.

15. The method of claim 9, wherein the high band comprises signals from 350-550 MHz, 350-880 MHz, 550 MHz-1 GHz.

16. The method of claim 9, wherein an amount of positive or negative slope adjustment provided by a variable slope adjusting circuit is determined based on the low band and the high band signal strength.
